(19) United States
(12) Patent Application Publication
(10) Pub. No.: US 2025/0178862 A1
(43) Pub. Date: Jun. 5, 2025

(54) ELEVATOR CONTROL DEVICE

(71) Applicant: Mitsubishi Electric Corporation, Tokyo (JP)

(72) Inventors: Eiji YUASA, Tokyo (JP); Takuya KANAYAMA, Tokyo (JP)

(73) Assignee: Mitsubishi Electric Corporation, Tokyo (JP)

(21) Appl. No.: 18/843,753

(22) PCT Filed: Mar. 14, 2022
(86) PCT No.: PCT/JP2022/011183

§ 371 Date: Sep. 4, 2024

(51) Int. Cl. B66B 1/34; B66B 3/00; B66B 5/00

(52) U.S. Cl. CPC B66B 1/3476; B66B 3/002; B66B 5/0012

(57) ABSTRACT

An elevator control device according to the present disclosure includes an acquisition unit, a judgment unit, and a control unit. The acquisition unit acquires an on-car weight that is a weight of a passenger or passengers inside a car and an on-hall weight that is a weight of a passenger or passengers in a hall. The judgment unit performs first judgment of judging whether or not the passenger or passengers in the hole can get in the car based on the on-car weight and the on-hall weight acquired by the acquisition unit. The control unit controls an elevator device according to judgment of the judgment unit.

### TECHNICAL FIELD

The present disclosure relates to an elevator control device.

### BACKGROUND ART

PTL 1 discloses an elevator control device that photographs passengers on a hall and passengers in a car by a camera, predicts an area in the car occupied by the passengers when the passengers in the hall get in the car, compares the area with a total area in the car, and thereby predicts whether or not there is/are a passenger/passengers left behind in the hall, that is, a passenger/passengers who cannot get in the car.

### CITATION LIST

### Patent Literature

[PTL 1] JP 2002-302348 A

### SUMMARY OF INVENTION

### Problem to be Solved by the Invention

The above-described elevator control device does not include the means for acquiring the weight of a passenger/passengers in the hall, and therefore, has a problem that it cannot judge whether or not the passenger or passengers can get in the car in consideration of the weight of the passenger or passengers in the hall.

The present disclosure is made in view of the above-described problem, and it is an object of the present disclosure to judge whether or not passenger or passengers can get in a car in consideration of a weight of the passenger or passengers in a hall, in an elevator control device.

### Means for Solving the Problem

An elevator control device according to the present disclosure comprises an acquisition unit that acquires an on-car weight that is a weight of a passenger or passengers inside a car and an on-hall weight that is a weight of a passenger or passengers in a hall, a judgment unit that performs first judgment of judging whether or not the passenger or passengers in the hall can get in the car based on the on-car weight and the on-hall weight acquired by the acquisition unit, and a control unit that controls an elevator device according to judgment of the judgment unit.

### Advantageous Effects of the Invention

According to the present disclosure, it is possible to judge whether or not the passenger or passengers can get in a car in consideration of the weight of the passenger or passengers in the hall in the elevator control device.

### BRIEF DESCRIPTION OF DRAWINGS

FIG. 1 is a figure showing the elevator device including an elevator control device in first embodiment.

FIG. 2 is a figure showing a configuration of the elevator device including the elevator control device in first embodiment.

FIG. 3 is a flowchart showing control when the control device in first embodiment judges whether or not to stop a car at a hall.

FIG. 4 is a flowchart showing control when the control device in first embodiment acquires on-hall weight.

FIG. 5 is a flowchart showing control when the control device in first embodiment indicates a message indicating a conditional stop.

FIG. 6 is a diagram showing information in a priority database of the control device in first embodiment.

FIG. 7 is a flowchart showing control when the control device in first embodiment updates a learned model for human weight.

FIG. 8 is a diagram a three-layer neural network.

FIG. 9 is a flowchart showing control when the control device in second embodiment judges whether or not to stop a car at a hall.

FIG. 10 is a flowchart showing control when the control device in third embodiment acquires on-hall weight.

### DESCRIPTION OF EMBODIMENTS

### First Embodiment

Hereinafter, an elevator device 100 including an elevator control device according to first embodiment will be described in detail based on the drawings. Note that same reference signs in the respective drawings denote the same or corresponding components and steps.

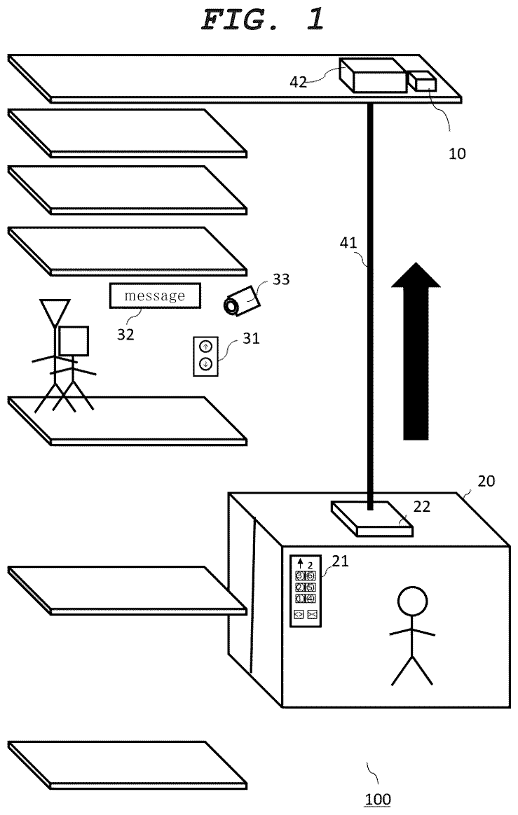

FIG. 1 is a figure showing the entire elevator device 100 in first embodiment. First, an outline of the entire elevator device 100 and an operation of the present embodiment will be described by using FIG. 1.

The elevator device 100 includes a control device 10 that is an elevator control device, a car 20, a hall call device 31, an indication device 32 indicating a message, a photographing device 33 that photographs a hall, a rope 41, a driving device 42 that moves the car 20, and doors of halls not illustrated. Further, the hall call device 31, the indication device 32, and the photographing device 33 are provided in the hall. The car 20 is provided with a car call device 21 and a load weighing device 22.

Hall call is to perform registration for causing the car 20 to go to a hall where an operation of calling the car 20 is performed by using the hall call device 31 included in the hall. Car call is to perform registration for causing the car 20 to go to a hall on a floor designated by a passenger by using the car call device 21 included in the car 20.

When the hall call and the car call are performed, the control device 10 causes the car 20 to go to destination floors in order in which the hall call and the car call are performed. The destination floor means a floor to which the car 20 goes, as registered by the car call and the hall call.

Note that when car call is performed to a hall on the way to the destination floor, the car 20 is stopped first at the hall on the floor designated by the car call. For example, even when the car call with the fifth floor as the destination floor is already performed in the hall on the first floor, if car call is performed for the hall on the fourth floor that is the hall on the way to the fifth floor, the car 20 stops first at the hall on the fourth floor, and thereafter goes to the hall on the fifth floor.

On the other hand, when hall call is performed by a passenger in a hall on the way to the destination floor, the control device 10 acquires an on-car weight that is a weight of passengers inside the car 20, and an on-hall weight that is a weight of passengers in the hall. Then, the control device 10 performs first judgment to judge whether or not the passengers in the hall can get in the car 20 based on the on-car weight and the on-hall weight. The control device 10 controls the elevator device 100 according to a result of the first judgment.

Specifically, when there is no passenger who can get in the car, the car 20 is caused bypass the hall, and when there is even only one passenger who can get in the car, the car 20 is stopped at the hall where the hall call is performed. Further, when the car 20 is caused to bypass the hall, and when there is even only one passenger that cannot get in the car even when the car 20 is stopped at the hall, a message is indicated in the hall by using the indication device 32.

According to the present embodiment, it is possible to perform judgment of whether or not the passenger or passengers can get in the car in consideration of the weight of the passenger or passengers in the hall. By controlling whether or not the car 20 is stopped at the hall according to the judgment of whether or not the passenger or passengers can get in the car, it is possible to avoid the situation where the car 20 cannot stop at the hall while the passenger or passengers cannot get in the car 20, and it is possible to improve transportation efficiency of the passengers. Further, when there is a passenger who cannot get in the car 20, the message is indicated at the hall, whereby the passenger in the hall can make decisions such as stopping waiting for the car 20, and therefore, the passenger in the hall can effectively utilize the time.

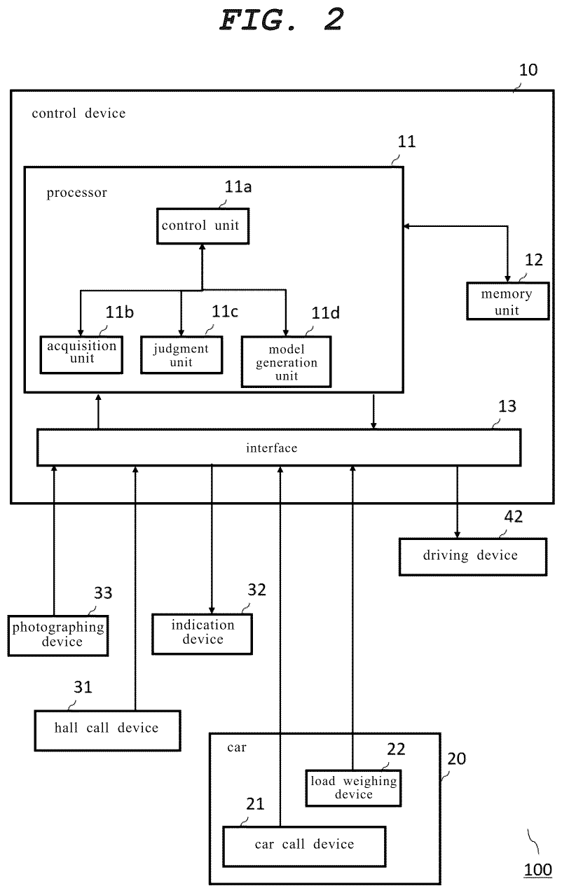

Next, a configuration of the control device 10 will be described in detail by using FIG. 2. The control device 10 includes a processor 11 that performs control, a memory unit 12, and an interface 13.

The processor 11 is a CPU (Central Processing Unit), and is connected to the memory unit 12, and the interface 13 to exchange information. The processor 11 includes a control unit 11a, an acquisition unit 11b, a judgment unit 11c, and a model generation unit 11d.

The control unit 11a includes software modules that perform control of the acquisition unit 11b, the judgment unit 11c, and the model generation unit 11d, and control of the entire elevator device 100 including the car 20, the hall call device 31, the indication device 32, the photographing device 33, the driving device 42, and the doors of the halls not shown.

Specifically, the control unit 11a includes a software module that performs registration of a destination floor of the car 20 when hall call and car call are performed. Further, the control unit 11a includes a software module that starts a process of performing judgment of whether to cause the car 20 to stop at the hall or bypass the hall when hall call is performed in the hall on the way to the destination floor of the car 20. Furthermore, the control unit 11a includes a software module that controls the driving device 42 to cause the car 20 to stop at the hall or bypass the hall according to the judgment of the judgment unit 11c described later. In addition, the control unit 11a includes a software module that causes the indication device 32 to indicate a message according to the judgment of the judgment unit 11c.

The acquisition unit 11b includes a software module that acquires an on-car weight that is the weight of the passenger or passengers inside the car 20 from the load weighing device 22. Further, the acquisition unit 11b includes a software module that acquires an image photographed by the photographing device 33, a software module that inputs acquired image information to a learned model for human weight, and outputs the weights of the passengers in the hall one by one to acquire the human weight, and a software module that adds up the acquired human weights to calculate the on-hall weight of the entire hall. Furthermore, the acquisition unit 11b includes a software module that inputs the acquired image information into a learned model for attribute information and outputs the attribute information of the passengers in the hall one by one to acquire the attribute information.

In the present disclosure, the on-hall weight means the weight of the passenger or passengers in the hall, and includes the weight of a specific part (for example, a weight of one person) of the passengers at the hall, and a total of the weights of all the passengers in the hall.

Here, the learned model for human weight of the present embodiment is a learned model for outputting a weight of one passenger in the hall from the image information. Further, the leaned model for attribute information is a learned model for outputting an attribute of the passenger in the hall from the image information. Note that the image information in the present embodiment is the image data itself but may be a feature quantity such as skeleton information extracted from the image data by a known algorithm. Furthermore, in the present disclosure, the attribute is classification of persons such as a person carrying a stretcher, a pregnant woman, an elderly person, or a person carrying a large load.

The judgment unit 11c includes a software module that judges whether or not the passenger in the hall can get in the car 20 based on the on-car weight and the on-hall weight acquired by the acquisition unit 11b with respect to the car 20 for which the hall call is performed by the passenger in the hall on the way to the destination floor.

The model generation unit 11d includes a software module that generates a learned model for inferring the on-hall weight from the image information by using learning data including the image information of the passenger in the hall acquired from the photographing device 33 by the acquisition unit 11b, and the on-car weight acquired from the load weighing device 22 by the acquisition unit 11b when the passenger in the hall gets in the car 20. In the present embodiment, the learning data generated based on a combination of the image information and the weight of the person in the image is memorized in the memory unit 12 described later. In the present embodiment, the software module is a software module that updates the learning data by adding a combination of image information of the passenger in the hall that is newly acquired from the photographing device 33, and a difference between car weights acquired from the load weighing device 22 before and after the passenger in the hall gets in the car 20, which corresponds to the weight of the person in the image, to this learning data, and a software module that generates a learned model for human weight that outputs a human weight when the image information is inputted, by using the updated learning data. Here, the learning data is data in which the image information and the weight of the person in the image are associated with each other. Further, the weight of the person in the image in the learning data of the present embodiment is a weight including luggage or the like held by the person in the image.

The memory unit 12 is a memory device configured by a nonvolatile memory and a volatile memory. The memory unit 12 memorizes the learned model for human weight and the learned model for attribute information. Further, the memory unit 12 memorizes a priority database 50 described later. Further, the memory unit 12 temporarily memorizes information generated by the process of the processor 11, and information inputted via the interface 13 from the car 20, the hall call device 31 and the photographing device 33.

The interface 13 includes terminals connecting electric lines not shown and connected to the car 20, the hall call device 31, the indication device 32, the photographing device 33, and the driving device 42. Note that the interface 13 includes terminals necessary for other motions of the elevator device 100. Further, the interface 13 may be connected to other configurations by wireless communication as a wireless communication device.

Subsequently, the other configurations of the elevator device 100 will be described by using FIG. 1.

The car call device 21 provided at the car 20 is a button device including a plurality of buttons in which names of floors are described, and is a button device that, when depressed by a passenger, outputs information about presence of car call and the depressed button to the control device 10.

The load weighing device 22 included in the car 20 cyclically measures a weight of the entire interior of the car 20 and outputs the weight to the control device 10.

The hall call device 31 is included at each hall and includes a button device for performing hall call. The button device includes a button for a rising direction and a button for a descending direction. When the button is depressed by a passenger, the button device outputs the fact that there is the hall call, and information about the direction of the depressed button to the control device 10.

The indication device 32 that is a notification device is equipped at each hall, and includes an LCD (Liquid Crystal Display) that indicates a message outputted from the control device 10. Further, the notification device may be any device if it can indicate a message outputted from the control device 10 and may be a projector or a voice. Further, if a user can understand the meaning, a color of a lamp may indicate whether the car 20 bypasses or stops.

The photographing device 33 that is a camera is equipped at each hall, photographs the hall, and outputs the photographed image to the control device 10.

The driving device 42 includes a traction machine to move the car 20 according to an instruction outputted from the control device 10. The traction machine moves the car 20 by winding up the rope 41 connected to the car 20 and a counterweight not shown.

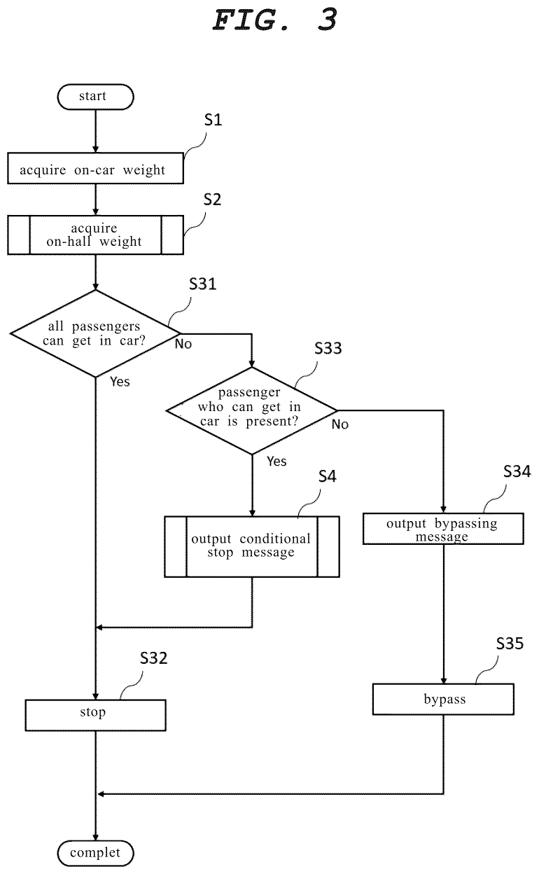

Next, an operation of the present embodiment will be described by using FIG. 3 to FIG. 8. FIG. 3 is a flowchart showing control of the control device 10 when judging whether to stop the car 20 at the hall or cause the car 20 to bypass the hall.

In the present embodiment, the control unit 11a of the control device 10 receives the information outputted by the hall call device 31 or the car call device 21 via the interface 13 and performs registration of the destination floor of the car 20, when a hall call or car call is performed by a passenger or a robot. The control unit 11a causes the car 20 to go to the hall on the destination floor in the order in which the hall call and the car call are performed. Specifically, an instruction is outputted to the driving device 42, and the car 20 is caused to move to the destination floor.

When a hall call is performed by a passenger in the hall on the way to the destination floor from the current position of the car 20, the control unit 11a starts a process of judging whether to cause the car 20 to stop at the hall where the hall call is performed or bypass the hall described in FIG. 3. Specifically, the process is started when the hall call is performed by the button in the same direction as the destination floor of the car 20 by the passenger. More specifically, when the rising direction button of the button device included in the hall call device 31 is depressed by the passenger and the control unit 11a receives the information outputted from the button device via the interface 13 when the destination floor of the car 20 is an upper floor than the hall, the control unit 11a starts the process. Note that when the car 20 is moving, and the car 20 cannot be decelerated and stopped before reaching the hall, the car can be caused to bypass the hall without performing the judgment.

When the hall call is performed by the passenger in the hall, and the control unit 11a starts the process, in step S1, the acquisition unit 11b acquires the on-car weight that is the weight of the passenger or passengers inside the car 20. Specifically, the weight of the entire interior of the car 20 outputted by the load weighing device 22 is received via the interface 13, and is temporarily memorized in the memory unit 12. Then, the acquisition unit 11b advances the process to step S2.

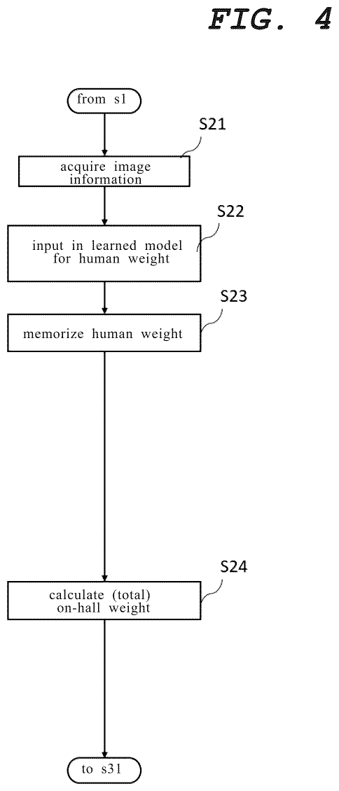

In step S2, the acquisition unit 11b acquires the on-hall weight that is the weight of the passenger or passengers in the hall. More specifically, the image obtained by photographing the hall where the hall call is performed and outputted by the photographing device 33 is received via the interface 13, and is temporarily memorized in the memory unit 12. Subsequently, the weight of each of the passenger or passengers in the hall and the total weight that are the on-hall weights are outputted from the image information of the acquired image by using the learned model for inferring the on-hall weight from the image information, and are temporarily memorized in the memory unit 12. Subsequently, the acquisition unit 11b advances the process to step S31. Details of step S2 will be described in detail later by using FIG. 4.

In step S31, the judgment unit 11c judges whether or not all the passengers in the hall where the hall call is performed can get in the car based on the on-car weight and the on-hall weight acquired by the acquisition unit 11b. Specifically, the judgment unit 11c judges whether or not the sum of the on-car weight and the total of the weights of all the passengers in the hall that are temporarily memorized in the memory unit 12 exceeds a rated load. When the sum does not exceed the rated load, the judgment unit 11c judges that all the passengers can get in the car, and advances the process to step S32. When the sum exceeds the rated load, the judgment unit 11c judges that all the passengers cannot get in the car and advances the process to step S33.

Note that as described later, in the process after step S33, the control unit 11a causes the indication device 32 to notify the message concerning whether or not the passenger or passengers can get in the car to the passenger or passengers in the hall. Therefore, when the judgment unit 11c judges that at least one or more of the passenger or passengers in the hall cannot get in the car in step S31, the control unit 11a causes the elevator device 100 to notify the message about whether or not the passenger or passengers can get in the car to the passenger or passengers in the hall.

In step S32, the control unit 11a outputs an instruction to the driving device 42 and causes the car 20 to stop at the hall where the hall call is performed. Then, the control unit 11a completes the process.

In step S33, the judgment unit 11c judges whether or not there is a passenger who can get in the car among the passengers in the hall where the hall call is performed, based on the on-car weight and the on-hall weight acquired by the acquisition unit 11b. Specifically, the judgment unit 11c calculates a sum of the on-car weight temporarily memorized in the memory unit 12 and the weight of each of the passengers in the hall, for each of the passengers in the hall, and judges whether or not there is a combination that is below the rated load. When there is the combination that is below the rated load, the judgment unit 11c judges that there is the passenger who can get in the car and advances the process to step S4. When there is no combination that is below the rated load, the judgment unit 11c judges that there is no passenger who can get in the car and advances the process to step S34.

In the present embodiment, the first judgment refers to step S31 and step S33, but the first judgment can be to judge whether or not the passenger or passengers in the hall can get into the car 20 based on the on-car weight and the on-hall weight acquired by the acquisition unit 11b, and may be only step S31 or only step S32.

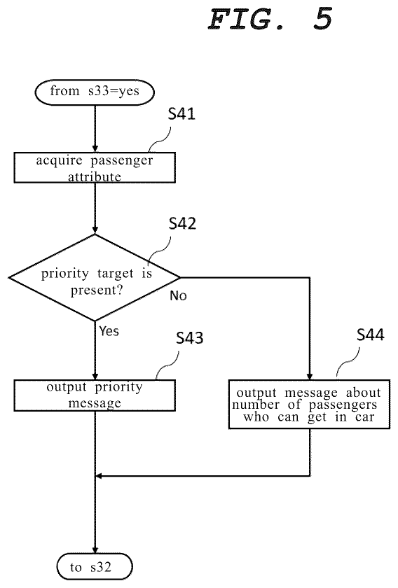

In step S4, the control unit 11a outputs an instruction to the indication device 32 to indicate a message indicating a conditional stop in which all the passengers in the hall cannot get in the car at the stop of the next car 20. Subsequently, the control unit 11a advances the process to step S32. Details of step S4 will be described later by using FIGS. 5 to 7.

On the other hand, in step S34, the control unit 11a outputs an instruction to the indication device 32 to indicate a message indicating that the car 20 bypasses the hall. Subsequently, the control unit 11a advances the process to step S35. In step S35, the control unit 11a outputs an instruction to the driving device 42 and causes the car 20 to bypass the hall where the hall call is performed. Subsequently, the control unit 11a completes the process.

According to the above, the control device 10 can perform judgment concerning whether or not the passenger or passengers can get in the car with the weight of the passenger or passengers in the hall taken into consideration. By controlling whether or not to stop the car 20 at the hall according to the judgment about whether or not the passenger or passengers can get in the car, it is possible to avoid the situation where the car 20 cannot stop at the hall while the passenger or passengers cannot get in the car 20, and improve the transport efficiency of the passengers. Further, when there is the passenger who cannot get in the car 20, the message is indicated at the hall, whereby the passenger in the hall can determine to stop waiting for the car 20 or the like, and therefore, the passenger in the hall can utilize the time effectively.

Next, a process of acquiring the on-hall weight by the acquisition unit 11b in step S2 will be described in detail by using FIG. 4. Step S2 includes four steps from step S21 to step S24.

In step S21, the acquisition unit 11b acquires image information. Specifically, the acquisition unit 11b receives the image obtained by photographing the hall where the hall call is performed and outputted by the photographing device 33 via the interface 13, and temporarily memorizes the image information in the memory unit 12. Subsequently, the acquisition unit 11b advances the process to step S22.

In step S22, the acquisition unit 11b inputs the image information acquired by the acquisition unit 11b in step S21 into the learned model for human weight memorized in the memory unit 12 and obtains the on-hall weight. Subsequently, the acquisition unit 11b advances the process to step S23. The on-hall weight outputted by the acquisition unit 11b by using the learned model for human weight in step S22 is more specifically the human weight that is the weight of each of the passengers in the hall.

In step S23, the acquisition unit 11b memorizes all the human weights that is the on-hall weight obtained in step S22. Subsequently, the acquisition unit 11b advances the process to step S24.

In step S24, the acquisition unit 11b adds up the human weights memorized in the memory unit 12 in step S23, calculates the total of the weights of all the passengers in the hall that is the on-hall weight, and memorizes it in the memory unit 12. Subsequently, the acquisition unit 11b advances the process to step S31.

According to the above, it is possible to easily acquire the weights of the passenger or passengers in the hall. Note that for solution of the problem, the method for acquiring the on-hall weight is not limited to this. For example, weight information may be received from potable terminals owned by the passenger or passengers.

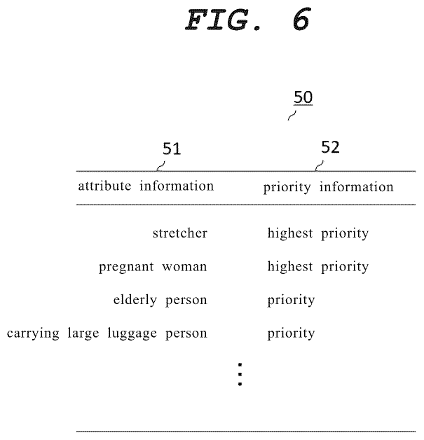

Next, step S4 will be described in detail by using FIG. 5 and FIG. 6. Four steps that are steps S41 to 44 are included.

In step S41, the acquisition unit 11b acquires attribute information of the passenger or passengers in the hall. More specifically, the image information of the image that is obtained by photographing the hall where the hall call is performed, and memorized in the memory unit 12 in step S21 is inputted into the learned model for attribute information, and attributes of all the passengers in the hall to be outputted are temporarily memorized in the memory unit 12. Subsequently, the acquisition unit 11b advances the process to step S42.

In step S42, the judgment unit 11c performs second judgment for judging whether or not there is a passenger with high priority to get in the car in the hall based on the attribute information acquired by the acquisition unit 11b. Specifically, the judgment unit 11c refers to the attributes of the passengers in the hall that are memorized by the acquisition unit 11b in step S41 and the priority database 50 memorized in the memory unit 12, and identifies priority information of the passengers in the hall. FIG. 6 is a diagram showing the information in the priority database 50. In the priority database 50, the attribute information 51 and the priority information 52 are memorized by being associated with each other. Then, the judgment unit 11c judges whether or not there is the priority information 52 of highest priority or priority in the priority information of the passengers in the hall.

When the judgment unit 11c judges that the passenger with high priority to get in the car is present in the hall, that is, when there is the priority information 52 of the highest priority or priority in the priority information of the passengers in the hall, the judgment unit 11c advances the process to step S43. Further, the judgment unit 11c memorizes the information for identifying the passenger the priority information of which is the highest priority or priority in the memory unit 12.

On the other hand, when the judgment unit 11c judges that there is no passenger with high priority to get in the car in the hall, that is, when there is not the priority information 52 of the highest priority or priority in the priority information of the passengers in the hall that is identified, the process is advanced to step S44.

In step S43, the control unit 11a outputs an instruction to the indication device 32 to indicate a message that the priority to get in the car is given to the passenger who is judged to have high priority in step S42. Specifically, the message is created based on the information that identifies the passenger the priority of which is the highest priority or priority and is memorized in the memory unit 12 in step S42, and is outputted. For example, when the information for identification is attribute information, the indication device 32 is caused to indicate the message “please give priority to get in the car to a pregnant woman” or the like. The information for identification may not be the attribute information, and for example, “please give priority to get in the car to those wearing red clothes”. Then, the control unit 11a advances the process to step S32.

Note that in the present disclosure, the message that a particular passenger is given priority to get in the car means that there is a passenger who cannot get in the car among the other passengers, and therefore is included in the message about whether or not the passengers can get in the car. Further, in the present embodiment, when there are a plurality of passengers judged to have high priority, the control unit 11a causes the indication device 32 to indicate a priority message for all the passengers judged to have high priority.

In step S44, the control unit 11a outputs an instruction to the indication device 32 to indicate a message indicating the number of persons who can get in the car. Then, the control unit 11a advances the process to step S32.

Note that in the present disclosure, the message indicating the number of persons who can get in the car means that there is a passenger who cannot get in the car among the passengers, and therefore is included in the message about whether or not the passenger or passengers can get in the car.

According to the above, the passenger or passengers who waits or wait in the hall where the hall call is performed can more accurately know whether or not they can get in the car when the car 20 stops, and therefore, use the time more effectively. Further, when there is a passenger with the attribute that should preferentially get in the car, the passenger easily gets in the car 20 preferentially.

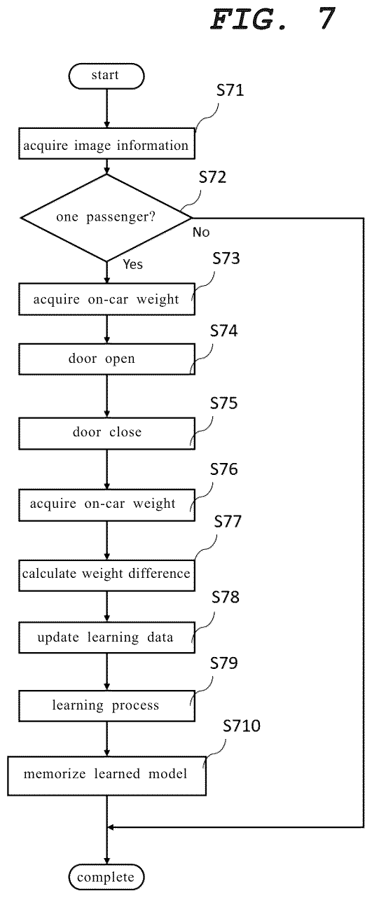

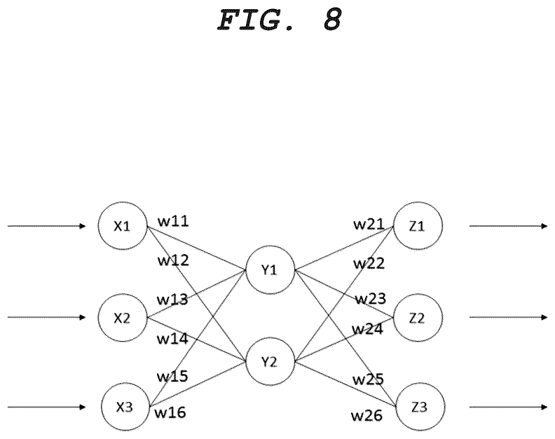

Next, by using FIG. 7 and FIG. 8, update of the learned model for human weight will be described. FIG. 7 is a flowchart showing control of the control device 10 when updating the learned model for human weight.

In the present embodiment, the control unit 11a starts a process of the update of the learned model for human weight when the car 20 arrives at the hall which is the hall where the hall call is performed, but is not on the destination floor of the car call.

When the control unit 11a starts the process, in step S71, the acquisition unit 11b acquires an image of the hall by a process similar to step S21, and advances the process to step S72.

In step S21, the acquisition unit 11b judges whether or not the number of passengers in the hall in the image memorized in the memory unit 12 in step S71 is one. When the number of passengers is one, the acquisition unit 11b advances the process to step S73, and when it is not one, the acquisition unit 11b completes the process.

In step S73, the on-car weight is acquired by a process similar to step S1, and the process is advanced to step S74.

In step S74, the control unit 11a opens the door of the hall and the door of the car 20, and advances the process to step S75. In step S75, the control unit 11a closes the door of the hall and the door of the car 20 by a normal process, when a door close instruction is outputted by an operation of the car call device 21 by the user, or a certain amount of time progresses. Then, the process is advanced to step S76.

In step S76, the acquisition unit 11b acquires the on-car weight by a process similar to step S1 and step S73, and advances the process to step S77.

In step S77, the acquisition unit 11b calculates a difference between the on-car weights acquired from the load weighing device 22 before and after the passenger or passengers in the hall gets or get in the car 20. Specifically, the difference between the on-car weights memorized in the memory unit 12 in step S73 and step S76 is calculated, and memorized in the memory unit 12. Then, the acquisition unit 11b advances the process to step S78. The difference between the on-car weights acquired from the load weighing device 22 before and after the passenger or passengers in the hall gets in the car 20 is the weight of the passenger or passengers in the hall.

In step S78, the model generation unit 11d updates learning data generated based on the combination of the image information memorized in the memory unit 12 and the weight of the person in the image. Specifically, the model generation unit 11d adds the combination of the image information acquired by the acquisition unit 11b in step S71, and the difference, calculated by the acquisition unit 11b in step S77, between the on-car weights acquired from the load weighing device 22 before and after the passenger or passengers in the hall gets in the car 20 to the learning data as the image information and the weight of the person in the image. Then, the model generation unit 11d advances the process to step S79.

In step S79, the model generation unit 11d generates a learned model for inferring the on-hall weight from the image information by using the learning data including the image information of the passenger or passengers in the hall, and the difference between the on-car weights acquired from the load weighing device 22 before and after the passenger or passengers in the hall gets in the car 20. Then, the process is advanced to step S710. Specifically, the model generation unit 11d generates the learned model for human weight by using the learning data updated in step S78.

A generation process of the learned model by the model generation unit 11d will be described in detail. A learning algorithm used by the model generation unit 11d in the present embodiment is known supervised learning. As an example, a case where a neural network is applied will be described.

The model generation unit 11d learns the weight of one passenger that is the on-hall weight by so-called supervised learning according to a neural network model, for example. The supervised learning herein refers to a method in which a set of input and result data is given to the learning device to thereby learn features in the learning data and infer results from the inputs.

The neural network is configured by an input layer composed of a plurality of neurons, an intermediate layer (hidden layer) composed of a plurality of neurons, and an output layer composed of a plurality of neurons. The number of intermediate layers may be one, or two or more.

For example, in the case of a three-layer neural network as shown in FIG. 8, when a plurality of inputs are inputted to input layers (X1 to X3), values thereof are multiplied by weights W1 (w11 to w16) to be inputted to intermediate layers (Y1 to Y2), and results thereof are further multiplied by weights W2 (w21 to w26) to be outputted from output layers (Z1 to Z3). The output results vary depending on values of the weights W1 and W2.

In the present embodiment, the neural network learns the weight of one passenger in the hall that is the on-hall weight by so-called supervised learning according to the learning data created based on the combination of the image information and the weight of the person in the image, including the combination of the image information of the passenger or passengers in the hall acquired by the acquisition unit 11b and the difference between the on-car weights acquired from the load weighing device 22 before and after the passenger or passengers in the hall gets in the car 20.

In other words, the neural network learns by adjusting the weights W1 and W2 so that the result outputted from the output layer after inputting the image data which is the image information to the input layer is close to the weight of the person in the image. The model generation unit 11d generates the learned model for human weight by executing the learning as above, and outputs it.

In step S710, the model generation unit 11d memories the learned model for human weight generated in step S79 in the memory unit 12 to update it. At this time, the previous learned model for human weight is deleted. Then, the model generation unit 11d completes the process.

According to the above, the learned model for human weight is updated, and the acquisition unit 11b can more accurately acquire the on-hall weight.

Note that in the present embodiment, the learned model for human weight is memorized in the memory unit 12 in advance. This is the result that the learned model generated by so-called supervised learning according to the learning data created based on the combination of the image information and the weight of the person in the image, by another learning device, is memorized in the memory unit 12. The learned model for attribute information is also generated similarly and memorized in the memory unit 12.

### Second Embodiment

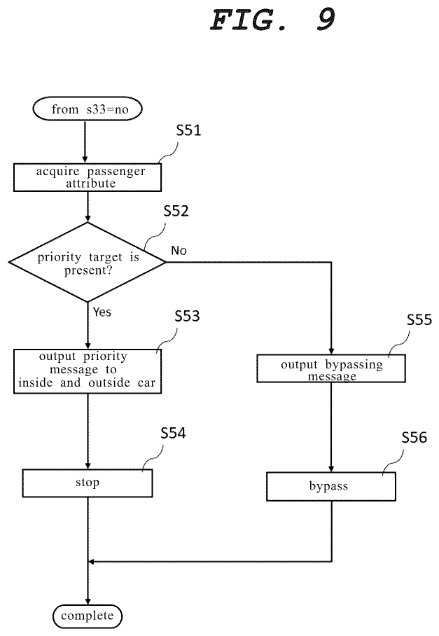

When the judgment unit 11c judges that there is no passenger who can get in the car in step S33 of first embodiment, the process is advanced to step S34, and the process in which the car 20 bypasses the hall is performed. In the present embodiment, even when it is judged that there is no passenger who can get in the car in a hall by the first judgment, if a passenger with high priority to get in the car is present in the hall, the car 20 is caused to stop at the hall. Hereinafter, a difference from first embodiment will be mainly described by using FIG. 9.

First, a configuration of the present embodiment will be described. In the present embodiment, an elevator device 100 includes an indication device similar to an indication device 32 in a hall, inside a car 20.

A control unit 11a of the present embodiment includes a software module that causes the car 20 to stop at a hall regardless of a result of the first judgment when a judgment unit 11c judges that there is a passenger with high priority to get in the car in the hall by second judgment.

Next, an operation of the present embodiment will be described. In the present embodiment, when the judgment unit 11c judges that there is no passenger who can get in the car in step S33 in FIG. 3, the process is advanced to step S51.

In step S51, an acquisition unit 11b acquires attribute information of the passenger or passengers in the hall similarly to step S41 in first embodiment. Subsequently, the process is advanced to step S51. In step S52, the judgment unit 11c performs the second judgment of judging whether or not there is a passenger with high priority to get in the car, in the hall similarly to step S42. Subsequently, when judging that there is a passenger with high priority to get in the car, in the hall, the judgment unit 11c advances the process to step S53. On the other hand, when it is judged that there is not passenger with high priority to get in the car, in the hall, that is, when there is not priority information 52 of the highest priority or priority in the priority information of the passenger or passengers in the hall that is specified, the process is advanced to step S55.

Note that in step S42, it is judged that there is a passenger with high priority to get in the car when the passenger with highest priority or priority of the priority information 52 is present, but in the judgment in step S52, a standard of evaluation may be changed from this. For example, in the present embodiment, it is judged that there is a passenger with high priority to get in the car, when the passenger with highest priority of the priority information 52 is present.

In step S53, the control unit 11a outputs an instruction to cause the indication device 32 and the indication device inside the car 20 to indicate a message that priority to get in the car is given to the passenger judged to have high priority in step S52. Subsequently, the process is advanced to step S54. In step S54, the control unit 11a stops the car 20 at the hall where the hall call is performed similarly to step S32, and completes the process.

In step S55, the control unit 11a outputs an instruction to cause the indication device 32 to indicate a message that the car 20 bypasses the hall similarly to step S34, and advances the process to step S56. In step S56, the control unit 11a causes the car 20 to bypass the hall where the hall call is performed similarly to step S35, and completes the process.

According to the above, even in the case where the car 20 bypasses the hall in first embodiment, the passenger with high priority to get in the car can get in the car 20. This is particularly useful when there is a passenger who has difficulty waiting for a long time in the hall (for example, when there is a passenger with the attribute of a stretcher or a pregnant woman having the highest priority of the priority information 52 in FIG. 6), and can reduce the waiting time of such a passenger. Further, in the present embodiment, the indication device is provided inside the car 20, and therefore the passenger or passengers in the car 20 can know in advance that they need to get off the car on the way.

### Third Embodiment

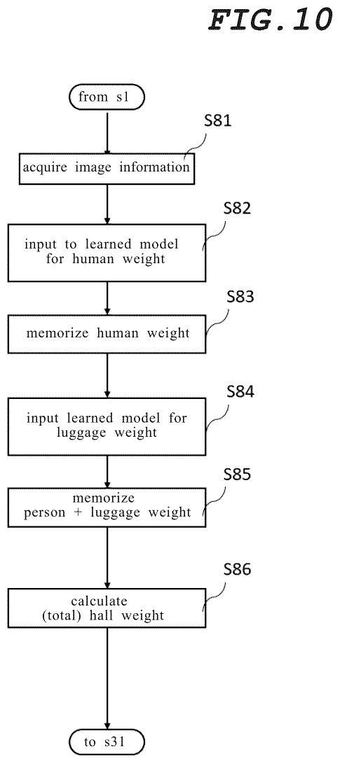

In step S2 of first embodiment, the acquisition unit 11b performs calculation of the on-hall weight using the learned model for human weight. In first embodiment, there is no distinction between the weight of people and the weight of luggage. In the present embodiment, the on-hall weight can be more accurately calculated by using a learned model for luggage weight in addition to the learned model for human weight. Hereinafter, a difference from first embodiment will be mainly described by using FIG. 10.

First, a configuration of the present embodiment will be described. A memory unit 12 of the present embodiment memorizes the learned model for human weight and the learned model for luggage weight.

In first embodiment, the learning model for human weight is generated according to the learning data created based on the combination of the image data that is the image information and the weight (the weight including luggage or the like held by the person in the image) of the person in the image. In the present embodiment, image information used in generation of a learned model for human weight and inference of an on-hall weight using this is a feature quantity of a human physique in an image extracted from image data by a known algorithm. The learned model for human weight in the present embodiment is a learned model generated according to learning data created based on a combination of the feature quantity of the human physique in the image that is the image information, and the weight (weight of the person himself or herself without including luggage or the like which can be inferred from the physique) of the person in the image.

A learned model for luggage weight is a learned model that is generated according to learning data that is created based on a combination of image information and a weight of luggage held by the person in the image. In the present embodiment, the image information used in generation of the learned model for luggage weight and inference of the on-hall weight using this is information about the way of holding the luggage of the person in the image extracted from the image data by a known algorithm. Since people change the way of holding luggage depending on the weight of the luggage, the weight of the luggage can be inferred from the way of holding it. For example, if a person holds luggage with both hands and bends down, it is obviously known that the person carries very heavy luggage. Further, a person carrying luggage in one hand can be seen to be carrying light luggage. Note that in the present disclosure, the on-hall weight includes the weight of the luggage of the passenger or passengers in the hall.

In the present embodiment, the acquisition unit 11b includes a software module that acquires a feature quantity of the human physique in the image and the information about the way of holding the luggage of the person in the image from the image data acquired from the photographing device 33. Further, the acquisition unit 11b includes a software module that acquires human weights by inputting the acquired feature quantities of the human physiques to the learned model for human weight and outputting the weight of the passengers in the hall one by one. Also, the acquisition unit 11b includes a software module that acquires the luggage weight by inputting the acquired information about the ways of holding the luggage of persons to the learned model for luggage weight and outputting the weights of the luggage of the passengers in the hall one by one. Also, the acquisition unit 11b includes a software module that calculates a total weight of the person himself or herself and the luggage for each passenger. Furthermore, the acquisition unit 11b includes a software model that calculates a total hall weight of all the passengers in the hall.

Next, an operation of the present embodiment will be described. In the present embodiment, the process is advanced from step S1 in FIG. 3 to step S81 shown in FIG. 10.

In step S81, the acquisition unit 11b acquires the image information. Specifically, the acquisition unit 11b receives the image obtained by photographing the hall where the hall call is performed and outputted by the photographing device 33 via the interface 13, and temporarily memorizes the image data in the memory unit 12. Then, the acquisition unit 11b extracts the feature quantities of the physiques of the passenger or passengers in the hall and the information about the ways of holding the luggage in the hall from the image data and memorizes them in the memory unit 12 in association with each of the passengers. Then, the acquisition unit 11b advances the process to step S82.

In step S82, the acquisition unit 11b inputs the feature quantities of the physiques of the passengers which are the image information acquired by the acquisition unit 11b in step S81 to the learned model for human weight memorized in the memory unit 12, and obtains the weights of the passengers themselves one by one. Then, the acquisition unit 11b advances the process to step S83.

In step S83, the acquisition unit 11b memorizes all the weights of the passengers themselves obtained in step S82. Then, the acquisition unit 11b advances the process to step S84.

In step S84, the acquisition unit 11b inputs the information about the ways of holding the luggage of the passengers which is the image information acquired by the acquisition unit 11b in step S81 to the learned model for luggage weight memorized in the memory unit 12, and obtains the weights of luggage one by one. Then, the acquisition unit 11b advances the process to step S85.

In step S85, the acquisition unit 11b adds up the weight of the passenger himself or herself obtained in step S82 and the weight of the luggage obtained in step S84 for each of the passengers, calculates the on-hall weight of each of the passengers, and memorizes all of them in the memory unit 12. Then, the acquisition unit 11b advances the process to step S86.

In step S86, the acquisition unit 11b adds up the on-hall weights of the respective passengers memorized in step S85, calculates the total hall weight, and memorizes the total hall weight in the memory unit 12. Then, the acquisition unit 11b advances the process to step S31.

According to the above, the control device 10 can more accurately calculate the on-hall weight.

The embodiments are described thus far, but the present invention is not limited to the embodiments. Modified examples are shown below.

In the embodiments, the acquisition unit 11b acquires the on-hall weight by the method of machine learning using the learned model. However, for the solution to the problem, the method for acquiring the on-hall weight is not limited to this. For example, the weights of the passenger or passengers may be memorized in advance in the terminals carried by the passenger or passengers in the hall, and the weights of the passenger or passengers in the hall may be acquired by wireless communication.

In the embodiments, the acquisition unit 11b outputs the weight and the attribute of each of the passengers by using the learned model, but the weights or the attributes of a plurality of persons may be outputted. For example, a learned model that has learned based on the learning data created based on the combination of the image data in which a plurality of persons is photographed or the feature quantities of the physiques, and the total of human weights of the plurality of persons in the image may be memorized in the memory unit 12 as the learned model for human weight. Then, the total hall weight may be directly calculated from the image data of the hall photographed by the photographing device 33.

Further, part of the software modules included by the acquisition unit 11b and the learned models memorized in the memory unit 12 may be placed on a cloud server. For example, the acquisition unit 11b may acquire the image information in step S21, thereafter, output the image information to the cloud server, and acquire the human weight from the cloud server after the cloud server performs the process of step S22. In other words, an inference device of the on-hall weight may be provided separately from the elevator control device. Further, in the embodiments, the learned model is memorized in advance in the memory unit 12, but the learning data may be accumulated from the beginning by using the control of update of the learned model for human weight described by using FIG. 7 to generate the learned model.

Note that in the embodiments, the case where the supervised learning is applied to the learning algorithm used by the model generation unit 11d is described, but the learning algorithm is not limited to this. For the learning algorithm, forced learning, unsupervised learning, semi-supervised learning or the like can also be applied other than the supervised learning. Further, as the learning algorithm used in the model generation unit 11d, deep learning (Deep Learning) that learns extraction of the feature quantity itself can also be used, and machine learning may be performed according to other known methods, such as genetic programming, functional logic programming, and a support vector machine, for example.

Further, the model generation unit 11d may perform human weight learning according to learning data created for a plurality of elevator devices 100. Note that the model generation unit 11d may acquire learning data from a plurality of elevator devices 100 used in a same area, or learn the human weight by utilizing learning data collected from a plurality of elevator devices 100 that operate independently in different areas. Further, it is also possible to add or remove the elevator device 100 from which learning data is collected to or from the target along the way. Furthermore, a learning device that has learned the human weight concerning a certain elevator device 100 may be applied to the different elevator device 100 from this, and the human weight may be relearned concerning the different elevator device 100 and updated.

In the embodiments, the judgment unit 11c judges whether or not the passenger or passengers in the hall can get in the car based on the on-car weight and the on-hall weight. In addition to this, a camera that photographs an inside of the car may be attached, and a free space and a floor projected area of the passenger or passengers in the hall may be compared to judge whether or not the passenger or passengers in the hall can get in the car.

In the embodiment, the classification of a person such as a stretcher, a pregnant woman, an elderly person, or a person carrying large luggage is illustrated as the attribute information used by the judgment unit 11c for the second judgment. As a matter of course, the classification of a person that is the attribute information is not limited to this. For example, a tired person or the like may be used.

Further, means for acquiring the attribute information may be a combination of a plurality of means. For example, attribute information of a fatigue degree may be treated independently from the other attribute information, a feature quantity of an expression is extracted by a known algorithm from the image of the face of a passenger in the hall, and the fatigue degree may be estimated by using a learned model that estimates the fatigue degree from the feature quantity of the expression, and thereby the attribute information that the passenger is tired may be acquired.

In the embodiment, the control unit 11a causes the indication device 32 to indicate the priority messages of all the passengers judged to have high priority, but may limit the passengers whose priority messages are indicated by the indication device 32 according to the priority level and the number of passengers capable of getting in the car. For example, the attribute information of the persons carrying large luggage, and the attribute information of the tired persons may be separately treated, the order of priority may be determined based on the other attribute information, and thereafter, the order of priority may be determined in the order of the weight of the luggage and the order of the fatigue degree.

In the embodiments, the elevator device 100 includes the only one car 20, but the elevator device 100 may include a plurality of cars 20, and the control device 10 may include a group control function. For example, when there is a passenger who cannot get in a certain car 20 among the passengers in the hall, the control unit 11a may cause the car 20 to bypass the hall and causes another car 20 to stop at the hall.

In the embodiment, the hall call device 31 includes the button for the rising direction and the button for the descending direction but may be the hall call device 31 with which the passenger can perform a hall destination call that designates a destination floor, in the hall. In this case, the control device 10 can recognize in advance at which hall the passenger in the car 20 gets off. Therefore, in the embodiment, the control unit 11a judges whether or not to cause the car 20 to bypass the hall in the hall where the hall call is performed, or outputs the priority message, but in addition to this, the judgment unit 11c may judge whether or not the passenger or passengers in the hall can get in the car based on an on-car weight after the passenger or passengers in the car 20 gets off on the destination floor and an on-hall weight in the hall that is the destination floor of the hall destination call.

### REFERENCE SIGNS LIST

10 control device, 11 processor, 11a control unit, 11b acquisition unit, 11c judgment unit, 11d model generation unit, 12 memory unit, 13 interface, 20 car, 21 car call device, 22 load weighing device, 31 hall call device, 32 indication device, 33 photographing device, 41 rope, 42 driving device, 50 priority database, 51 attribute information, 52 priority information, 100 elevator device

1. An elevator control device, comprising:
at least one processor, wherein
the processor is configured to cause the elevator control device to at least:
acquire an on-car weight that is a weight of a passenger or passengers inside a car and an on-hall weight that is a weight of a passenger or passengers in a hall;
perform first judgment of judging whether or not the passenger or passengers in the hall can get in the car based on the on-car weight and the on-hall weight; and
control an elevator device according to the first judgment, wherein
the processor is configured to cause the elevator control device to
acquire image information of the passenger or passengers in the hall photographed by a photographing device, and
output the on-hall weight from the acquired image information of the passenger or passengers in the hall by using a learned model for inferring the on-hall weight from the image information, and thereby acquires the on-hall weight.

2. (canceled)

3. The elevator control device according to claim 1,
wherein the image information includes information about a way of holding luggage of the passenger or passengers in the hall, and
the learned model is for inferring a weight of the luggage from the information about the way of holding the luggage of the passenger or passengers in the hall included in the image information.

4. The elevator control device according to claim 1,
wherein the processor is configured to cause the elevator control device to
acquire the on-car weight acquired from a load weighing device of the car,
use learning data including image information of the passenger or passengers in the hall and a difference between the on-car weights acquired from the load weighing device before and after the passenger or passengers in the hall gets or get in the car, and generate a learned model for inferring the on-hall weight from the image information.

5. The elevator control device according to claim 1,
wherein the processor is configured to cause the elevator control device to, when judged that at least one or more of the passenger or passengers in the hall cannot get in the car based on the first judgment, cause the elevator device to notify the passenger or passengers in the hall of a message about whether or not the passenger or passengers in the hall can get in the car.

6. The elevator control device according to claim 5,
wherein the processor the processor is configured to cause the elevator control device to
acquire attribute information of the passenger or passengers in the hall,
perform second judgment of judging whether or not there is a passenger having high priority to get in the car in the hall based on the attribute information, and
when judged that at least one or more of the passenger or passengers in the hall cannot get in the car based on the first judgment, and judged that there is a passenger with the high priority to get in the car in the hall based on the second judgment, cause the elevator device to notify a message that priority to get in the car is given to the passenger with the high priority to get in the car.

7. The elevator control device according to claim 1,
wherein the processor the processor is configured to cause the elevator control device to,
when judged that the passenger or passengers in the hall can get in the car based on the first judgment, cause the car to stop at the hall, and
when judged that the passenger or passengers in the hall cannot get in the car, cause the car to bypass the hall.

8. The elevator control device according to claim 7,
wherein the processor the processor is configured to cause the elevator control device to,
acquire attribute information of the passenger or passengers in the hall,
perform second judgment of judging whether or not there is a passenger with high priority to get in the car in the hall based on the attribute information, and
when judged that there is the passenger with the high priority to get in the car in the hall based on the second judgment, cause the car to stop at the hall regardless of the first judgment.
